(19) United States
(12) Patent Application Publication
(10) Pub. No.: US 2009/0055721 A1
(43) Pub. Date: Feb. 26, 2009

(54) PATENT CLAIM VISUALIZATION SYSTEM AND METHOD

(76) Inventor: MICHAEL R. KAHN, WESTAMPTON, NJ (US)

Correspondence Address: MICHAEL R. KAHN, P.O. BOX 184, MOUNT HOLLY, NJ, 08060, US

(21) Appl. No.: 12/195,364

(22) Filed: Aug. 20, 2008

Related U.S. Application Data
(60) Provisional application No. 60/957,703, filed on Aug. 23, 2007.

(51) Int. Cl. G06F 17/00

(52) U.S. Cl. 715/205; 715/230

(57) ABSTRACT

Systems and methods are disclosed for patent claim visualization that automatically generate a visual claim hierarchy graph from a listing of the claim text. Rejection information may be added automatically by lexically analyzing an Office Action. Additionally, the user of this system can then provide additional information, including descriptions of the claim elements, and any rejections applied to the claims. Embodiments of the present invention can generate a visual representation of each claim, as well as indicating references and technical issues applied against those claims as part of the office action. In an exemplary embodiment, the visual information is presented in an HTML page, such that it may be viewed with a conventional HTML browser, and may be interacted with by the user to quickly see the rejections applied to any given claim. Embodiments of the present invention also provide different symbols for rejected versus non-rejected claims. This allows the user to quickly identify which claims are rejected, versus those that are non-rejected (allowed or merely objected to).

### CROSS REFERENCE TO RELATED APPLICATIONS

This application claims benefit to U.S. Provisional Application Ser. No. 60/957,703, filed on Aug. 23, 2007.

### FIELD OF THE INVENTION

The present invention relates to computerized analysis of patent disclosures. More particularly, the present invention relates to methods and systems for visualizing patent claims and related information.

### BACKGROUND

Writing or revising claims for a patent disclosure can require a practitioner to keep track of many pieces of information. The task can be especially daunting in the case of preparing a response for an application that they did not write, and are not so familiar with the original claims. If there are many claims, and many rejections, the time spent just getting a handle on the claims and the various rejections can be excessive. Furthermore, it is not unusual to be up against short, non-extendable deadlines when filing a response. Additionally, there is also a need to keep track of claims as a new application is drafted. Therefore, what is desired is a means to aid in timely and effective managing of claims and related information when filing patent applications, responses, and amendments.

### SUMMARY OF THE INVENTION

The present invention provides a system and method for patent claim visualization that automatically generates a visual claim hierarchy graph from a listing of the claim text. The user of this system can then provide additional information, including descriptions of the claim elements, and any rejections applied to the claims. The system of the present invention then generates a visual representation of each claim, and references and technical issues applied against those claims as part of the rejections. In one embodiment, the visual information is presented in an HTML page, such that it may be viewed with a conventional HTML browser, and may be interacted with by the user to quickly see the rejections applied to any given claim. The present invention also provides different symbols for rejected versus non-rejected claims. This allows the user to quickly identify which claims are rejected, versus those that are non-rejected (allowed or merely objected to).

### BRIEF DESCRIPTION OF THE DRAWINGS

FIG. 1 shows a flowchart of a method in accordance with an embodiment of the present invention.

FIG. 2 shows a flowchart of a method in accordance with an alternative embodiment of the present invention.

FIG. 3 shows an example of a rejection statement.

FIG. 4 shows a sample claims graph generated by an embodiment of the present invention.

FIG. 5 shows a graph indicated rejected and non-rejected claims in accordance with an embodiment of the present invention.

FIG. 5B shows an excerpt of an HTML file in accordance with an embodiment of the present invention.

FIG. 6 shows a graphical representation of a claim attack diagram, in accordance with an additional embodiment of the present invention.

FIG. 7 shows a block diagram of a system in accordance with an embodiment of the present invention.

### DESCRIPTION OF THE INVENTION

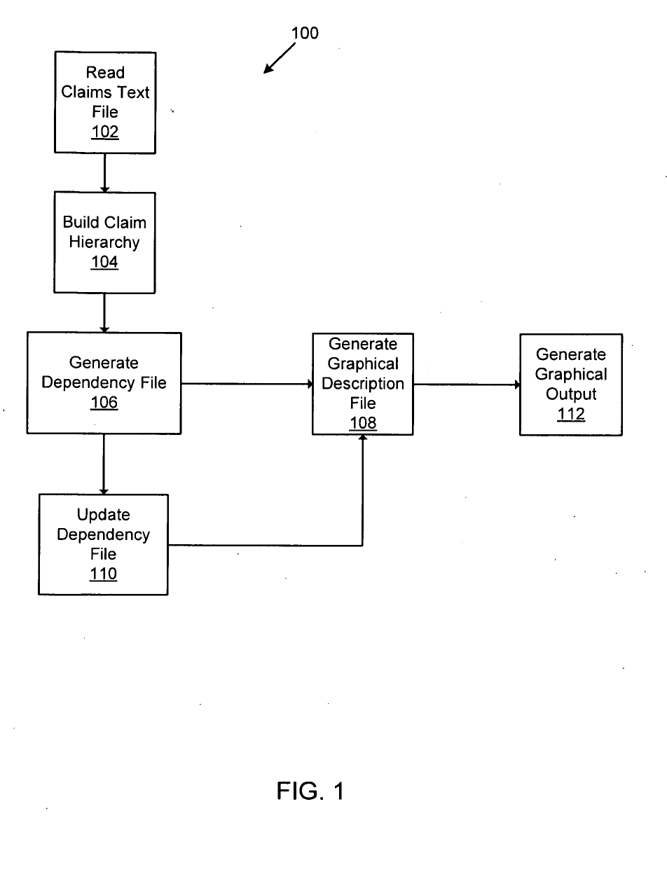

FIG. 1 shows a high level flow diagram 100 of a preferred method of using the present invention. In step 102, a text file containing each numbered claim is read. The claims are read by a computer executing machine instructions to determine a claim hierarchy. This is done by tokenizing the claim, and searching for the token “claim” followed by a digit. The “digit” token is interpreted to be the parent claim. If no such token is found at the end of the claim, then the claim is deemed to be independent.

In step 104, this hierarchy is built and recorded in computer memory. In step 106, the claim hierarchy is represented in a file, referred to as a CLDEP file (CLaim DEPendency file). Claim parsing and formation of a claim tree is known in the art. For example, published U.S. patent application Ser. No. 11/949,039 (publication number 20080147656), entitled: “Computer Aided Validation of Patent Disclosures” discloses claim parsing, and is incorporated herein by reference.

In step 108, a graphical description file is generated. The graphical description file is used by a graphics engine to render a graphical output. In one embodiment, the graphical description file is in the “dot” format, suitable for use by Graphviz (an open source graphics program). From the graphical description file, graphical output is generated. The output formats may include JPEG and PNG image files, as well as Postscript, and PDF formats. Other formats are possible and within the scope of the present invention. The graphical output may be an image file that is embedded into a web based format file, such as an HTML file, for example.

In step 110, the user optionally updates the dependency (CLDEP) file to indicate claim elements or rejection information. This information is then incorporated into the generated output in step 112.

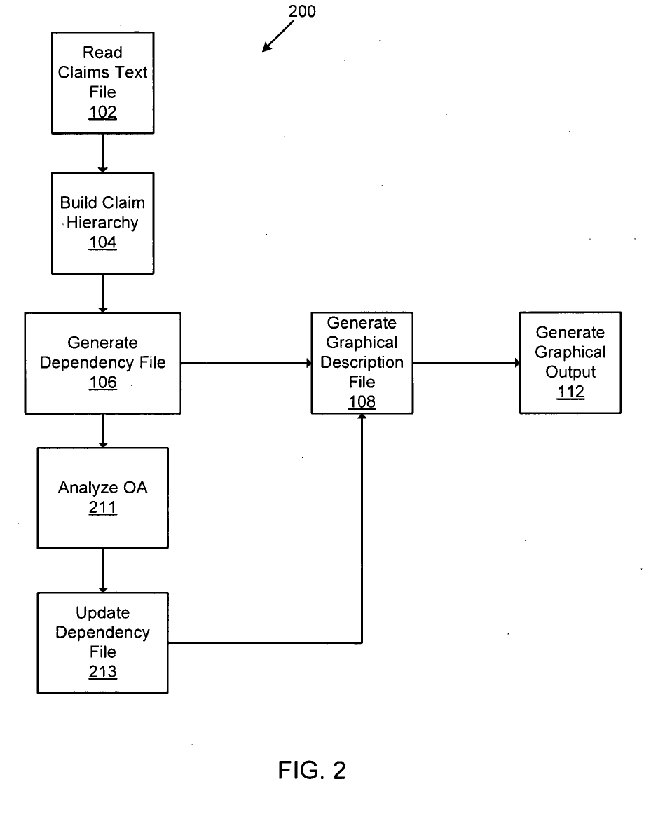

FIG. 2 shows a high level flow diagram 200 of a an alternative embodiment of the present invention. In this embodiment, after step 106, an Office Action is automatically analyzed to extract claim rejection information. The process to carry out step 211 may involve:
performing OCR (optical character recognition) on the pdf file of the Office Action;
tokenizing the text;
identifying the rejected claims;
identifying each rejection that applies to each rejected claim; and
identifying the references that are used to form each rejection.

In step 213, the dependency file is updated to incorporate the information generated in step 211. Additional information may be manually added at this time, such as specific claim elements that are anticipated, or considered obvious by a combination of references.

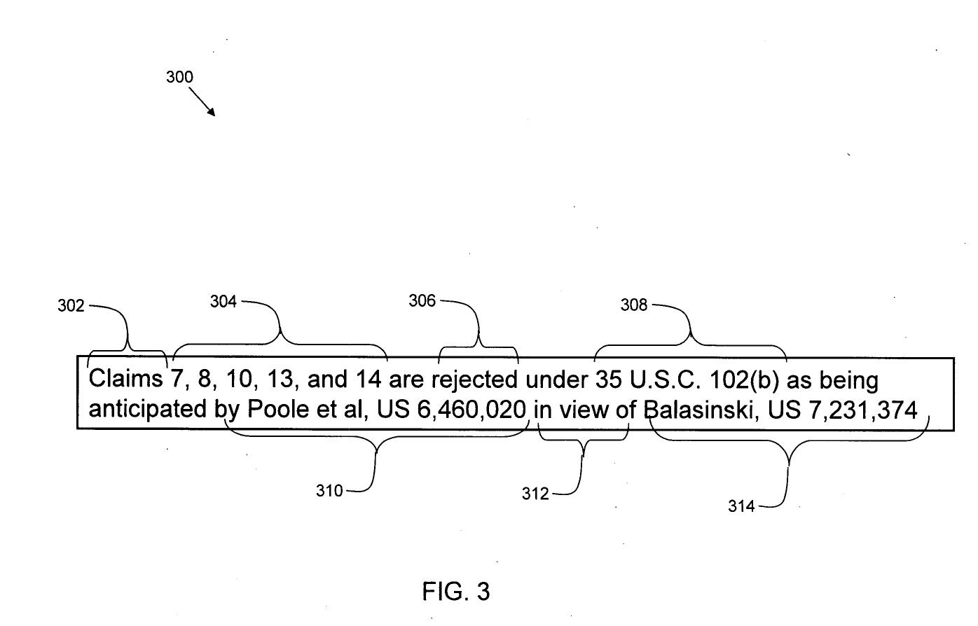

FIG. 3 shows an example rejection statement 300 from an Office Action:

“Claims 7, 8, 10, 13, and 14 are rejected under 35 U.S.C. 102(b) as being anticipated by Poole et al, U.S. Pat. No. 6,460,020 in view of Balasinski, U.S. Pat. No. 7,231,374.”

FIG. 3 illustrates a possible parsing scheme. As stated previously, the text of the Office Action is tokenized, and then analyzed to find claim rejection information. Certain combinations of adjacent or nearby tokens may be categorized into token groups. For example, token 302 may indicate the start of a possible rejection statement, being of the wording “Claim” or “Claims.” Token 306, “rejected” is used to indicate that the token group 304 contains the numbers of the rejected claims. Token group 308 indicates the type of rejection. Token group 310 and 314 indicate reference information. Token group 312 (the phrase “in view of”) indicates relationship information amongst the two references. This information can be conveyed graphically, as will be shown in an upcoming figure.

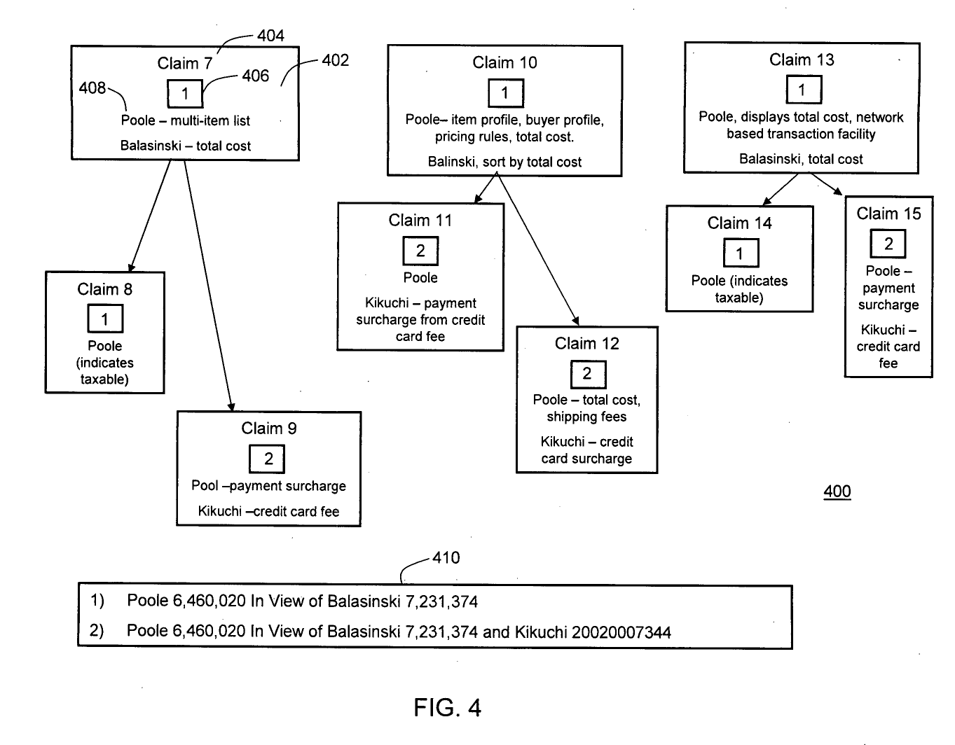

FIG. 4 shows a sample claims graph (also referred to as a claim tree) 400 generated by an embodiment of the present invention. For each rejected claim, a claim information box 402 is rendered. Note that while a rectangle is shown in this embodiment, the claim information box may be of another shape, such as circle or oval, without departing from the scope of the present invention. However, for convenience, the term claim information box” will be used, even to refer to a shape that is not “box-like.” The claim number is indicated in the claim field, shown as reference 402. The claims are rendered in a hierarchical manner, such that it can quickly be ascertained as to which claims are the parent claims of the dependent claims. For example, in FIG. 4, claims 7, 10, and 13 are independent claims, and claim 8 and 9 are dependent claims that depend from claim 7, and so on. Within each claim information box is a rejection code, indicated by reference 406. The rejection code 406 identifies the reason for the rejection. Details of each rejection are shown in the rejection summary 410, shown proximal to the claim tree 400, in this case, at the bottom of FIG. 4. In this example, the user can quickly see that the rejection code for claim 7 is 1, whereas the rejection code for claim 9 is 2. The user can refer to the rejection summary to see that a rejection code of 1 means that a claim is rejected due to Poole U.S. Pat. No. 6,460,020 In View of Balasinski U.S. Pat. No. 7,231,374, and a rejection code of 2 means that a claim is rejected due to Poole U.S. Pat. No. 6,460,020 In View of Balasinski U.S. Pat. No. 7,231,374 and Kikuchi 20020007344. The rejection elements field 408 shows the specific claim elements that each reference is said to show. For example, in the case of claim 7 shown in FIG. 4, the rejection element field 408 shows that the Poole reference shows a multi-item list, whereas the Balasinski reference shows the total cost, presumably causing the rejection of claim 7. Note that some of the information, such as that in the rejection elements field 408 may be entered manually in the claim dependency file, such as in steps 110 or 213 of the previously described methods. The graph 400 has the advantage of having the pertinent information in one graph, which is well suited for printing a hard copy of the information.

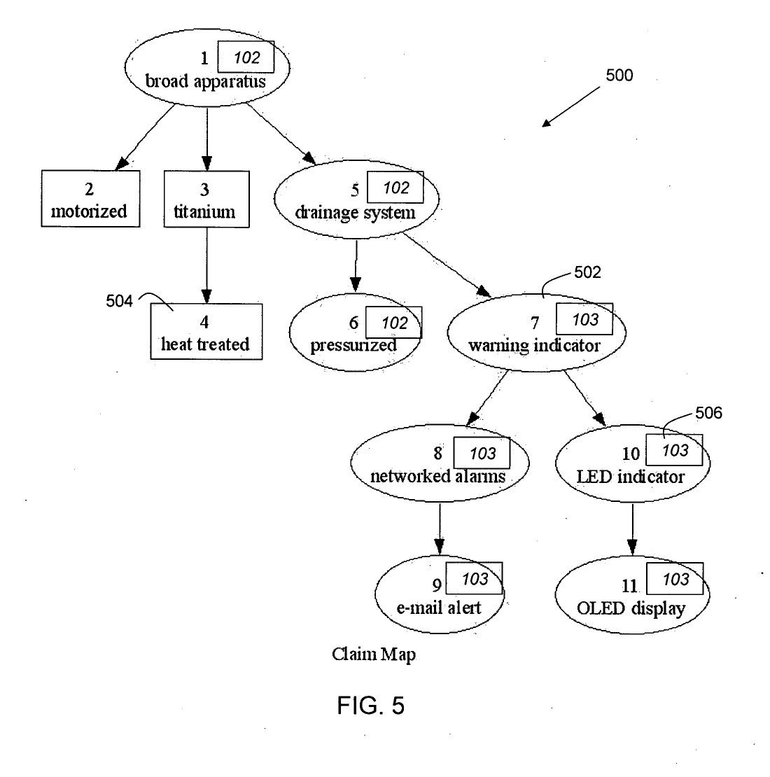

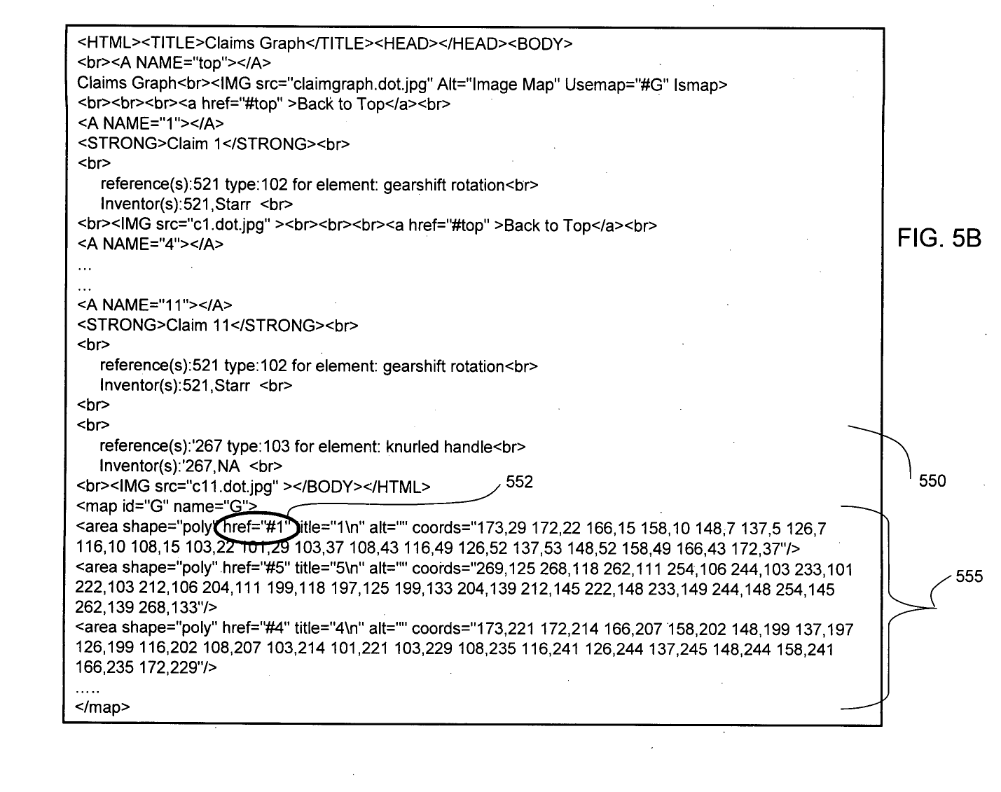

FIG. 5 shows a graph 500 indicating rejected and non-rejected claims in accordance with an alternative embodiment of the present invention. In this embodiment, the claims are graphed in hierarchical order, with each claim icon being rendered with a shape indicative of its current status. In the embodiment shown, rejected claim icons are rendered with ovals 502, and non-rejected claim icons are rendered as rectangles 504. In another embodiment, a third shape may be used to indicate objected claims (not shown). In one embodiment, chart 500 is embedded in an HTML file (or other file supporting hyperlinks, such that when a user clicks on a rectangle or oval, a claim attack diagram is shown for the corresponding claim. This embodiment is well suited for use on a PC, or other computing device that allows the selection of document links. In one embodiment, a means for establishing a link between each rejected claim in the claim tree and a corresponding claim attack diagram may be achieved by generating a map file with the Graphviz graphics package. The map file is then appended to an HTML file, which allows the HTML page to provide URLs to the claim details of the rejected claims. FIG. 5B shows an excerpt 550 of a sample HTML page, with the map file information 555 appended at the end of the page. The map file may contain one or more URLs (shown generally as reference 552) that point to a specific claim attack diagram for a specific claim. Hence, when the user clicks on a claim icon for a claim that has been rejected, its URL is invoked, causing the corresponding claim attack diagram to be displayed.

Rejection type field 506 indicates the rejection type for each rejected claim. In the example shown, the field indicates “102” or “103”, which correspond to sections of U.S. patent regulations. In another embodiment, the specific subtype of the rejection may be shown in rejection type field 506, such as “102b” for example.

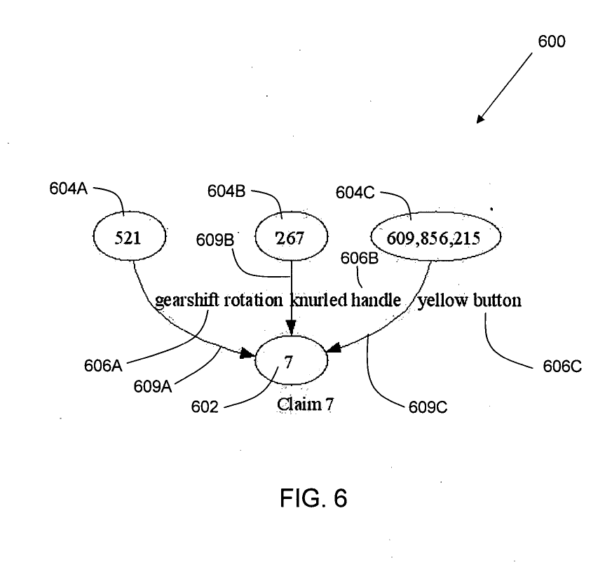

FIG. 6 shows a claim attack diagram 600 in accordance an embodiment of the present invention. A claim attack diagram is a graphical representation of references applied against a claim. The claim icon 602 indicates the claim that is currently being rejected, in this case, claim 7. For each reference, or combination of references, used to reject a claim, a reference icon (604A-604C) is rendered. Reference icons 604A and 604B pertain to a single reference, whereas reference icon 604C pertains to a combination of references. Note that the claim attack diagram 600 of FIG. 6 is showing only the last three numbers of the reference in each reference icon (604A-604C), as a space saving measure. However, other embodiments are contemplated that show each reference number in its entirety, possibly with bibliographic information. This may be accomplished by using larger reference icons and/or a smaller font. Other techniques, such as text windows that dynamically appear when a cursor is placed over a reference icon, may also be used to convey the information. Each reference icon (604A-604C) may be have a connection (609A-609C) rendered to show a relationship between the reference icons and the claim icon 602. Claim element labels (606A-606C), rendered proximal to each connection (609A-609C) indicate the element that each reference shows to comprise the basis for the rejection. For example, a practitioner using this claim attack diagram 600 can quickly see that the patent Examiner is using the '267 to form part of a basis for rejection of claim 7, due to a knurled handle. By viewing the information graphically, a practitioner can quickly ascertain the summary of the rejections. Furthermore, the graphical information presented in embodiments of the present invention can assist a practitioner in determining a strategy of which claims and references to focus on in order to best respond to the rejections. Using a system of graphs similar to those shown in FIGS. 5 and 6, wherein each rejected claim shown in FIG. 5 has a corresponding claim attack diagram (see 600 of FIG. 6) that is presented when a claim icon (see 502 of FIG. 5) is clicked on with a mouse, or other suitable selecting mechanism.

Below is a sample excerpt of a claim dependency file, similar to that which was used to generate FIGS. 5 and 6.

ClaimHierarchy
1,0,broad apparatus
2,1,motorized
3,1,titanium
4,3,heat treated
5,1,drainage system
6,5,pressurized
7,5,warning indicator
8,7,networked alarms
9,8,e-mail alert
10,7,LED indicator
11,10,OLED display
References
“521”:“Starr”
“267”:“Lennon”
“609”:“Schmidt”
“856”:“Aaron”
“215”:“Ruth”
Rejections
“1,5-11”:“521”:“102”:“gearshift rotation”
“6,5-11”:“‘267”:“103”:“knurled handle”
“7”:“609,856,215”:“103”:“yellow button”

FIGS. 5 and 6 were created with the Graphviz package. However, any suitable graphics package may be used to implement embodiments of the present invention. Graphviz is only one example of such a graphics package. Graphviz uses dot files as input to generate graphs. It is available at www.graphviz.org. However, another graphics rendering tool may be used, so long as it can render the necessary shapes.

Below is a sample of a dot file similar to that used to generate FIG. 5.

digraph G {label=“Claim Map”;node [shape = ellipse];
1
[label = “1\nbroad apparatus”][URL=“#1”]
node [shape = box];
2
[label = “2\nmotorized”][URL=“”]
node [shape = box];
3
[label = “3\ntitanium”][URL=“”]
node [shape = box];
4
[label = “4\nheat treated”][URL=“”]
node [shape = ellipse];
5
[label = “5\ndrainage system”][URL=“#5”]
node [shape = ellipse];
6
[label = “6\npressurized”][URL=“#6”]
node [shape = ellipse];
7
[label = “7\nwarning indicator”][URL=“#7”]
node [shape = ellipse];
8
[label = “8\nnetworked alarms”][URL=“#8”]
node [shape = ellipse];
9
[label = “9\ne-mail alert”][URL=“#9”]
node [shape = ellipse];
10
[label = “10\nLED indicator”][URL=“#10”]
node [shape = ellipse];
11
[label = “11\nOLED display”][URL=“#11”]
1;
1 -> 2;
1 -> 3;
3 -> 4;
1 -> 5;
5 -> 6;
5 -> 7;
7 -> 8;
8 -> 9;
7 -> 10;
10 -> 11;
}

Below is an example of a dot file for a claim attack diagram (see 600 of FIG. 6).

digraph G {
label=“Claim 4”;
“521” -> 4[label = “gearshift rotation”];
“‘267” -> 4[label = “knurled handle”];
}

In one embodiment, a user enters the specific element information, such as “gearshift rotation” into the dot file via a text editor. In another embodiment, a typical GUI (graphical user interface) front end is used to allow the user to enter the information, and automatically insert it into the dot file with the proper format and syntax.

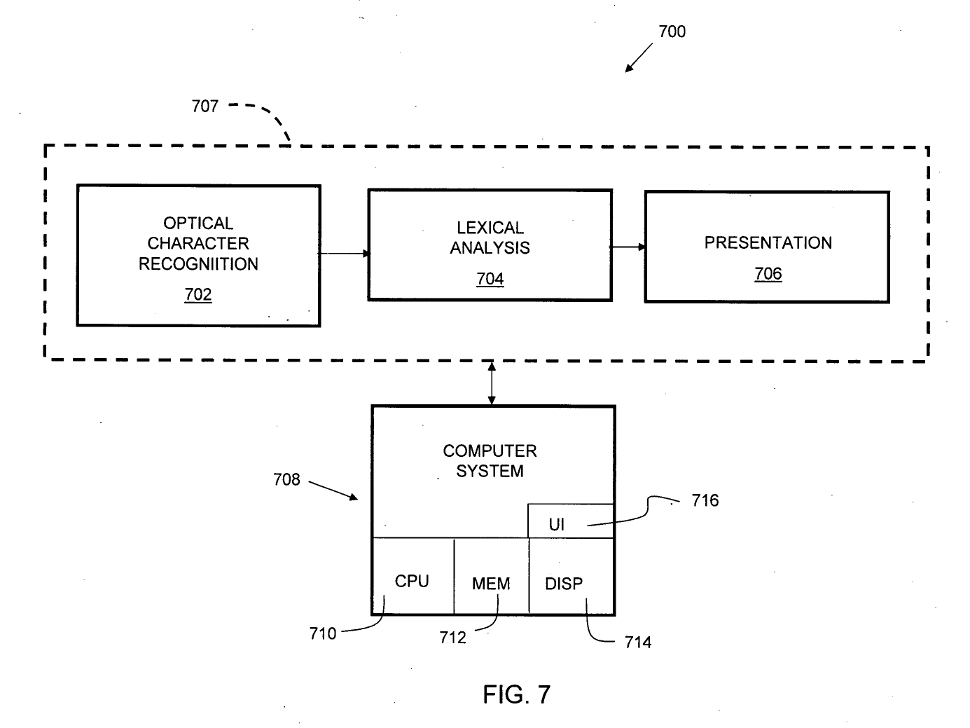

FIG. 7 shows a block diagram of a system 700 in accordance with an embodiment of the present invention. Computer system 708 comprises CPU 710, which executes software instruction residing in memory 712, and renders the information on a display 714. Memory 712 may include RAM, ROM, Hard Disk, or other computer-readable medium suitable for storing executable instructions. A user interacts with computer system 708 via user interface 716, which may comprise a keyboard, mouse, or other suitable data entry and navigation mechanisms. Executing on CPU 710 (note multiple CPU's or “cores” may be present in computer system 708) is software 707, which comprises optical character recognition module 702, lexical analysis module 704, and presentation module 706. The optical character recognition module 702 is used to convert Office Actions from a graphical format, such as PDF or TIFF, to a text format, where the data is then supplied to lexical analysis module 704, which then provides a results file which is supplied to presentation module 706 for graphical rendering.

As can be appreciated, the above disclosed system and method provide for improved patent claim visualization The present invention provides a practitioner with a powerful set of tools and methods for quickly assessing rejections from an Office Action.

It will be understood that the present invention may have various other embodiments. Furthermore, while the form of the invention herein shown and described constitutes a preferred embodiment of the invention, it is not intended to illustrate all possible forms thereof. It will also be understood that the words used are words of description rather than limitation, and that various changes may be made without departing from the spirit and scope of the invention disclosed. Thus, the scope of the invention should be determined by the appended claims and their legal equivalents, rather than solely by the examples given

What is claimed is:

1. A computer-readable medium comprising computer-executable instructions for performing a method comprising:
analyzing a set of claims to form a claim hierarchy;
receiving rejection information pertaining to the set of claims; and
rendering a graphical representation of the set of claims in a claim tree, the claim tree comprising a plurality of claim icons, and wherein a rejection status for each claim is indicated in the claim tree.

2. The computer-readable medium of claim 1, wherein the computer-executable instructions for performing a method further comprise rendering a first shape for each claim icon within a claim tree that is rejected, and rendering a second shape for each claim icon within a claim tree that is not rejected.

3. The computer-readable medium of claim 1, wherein the computer-executable instructions for performing a method further comprise instructions for storing the reference bibliographic information into a writable computer-readable medium, whereby the reference bibliographic information is displayed in the graphical representation of the set of claims in a claim tree.

4. The computer-readable medium of claim 3, wherein the computer-executable instructions for performing a method further comprise instructions for storing the rejection type into a writable computer-readable medium, whereby the rejection type is displayed in the graphical representation of the set of claims in a claim tree.

5. The computer-readable medium of claim 4, wherein the computer-executable instructions for performing a method further comprise instructions for storing the rejection elements into a writable computer-readable medium, whereby the rejection elements are displayed in the graphical representation of the set of claims in a claim tree.

6. The computer-readable medium of claim 1, wherein the computer-executable instructions for performing a method further comprise using a first color to render each claim icon within a claim tree that is rejected, and using a second color to render each claim icon within a claim tree that is not rejected.

7. The computer-readable medium of claim 1, wherein the computer-executable instructions for performing a method further comprise instructions for:
performing optical character recognition on an office action to create a text file;
tokenizing the text file;
identifying the rejected claims;
identifying each rejection that applies to each rejected claim;
identifying the references that are used to form each rejection; and
rendering an indication of the rejected claims, rejections that apply to each claim, and references used to form each rejection in the claim tree.

8. The computer-readable medium of claim 1, wherein the computer-executable instructions for performing a method further comprise instructions for:
generating a claim attack diagram for each rejected claim; and
displaying the claim attack diagram.

9. The computer-readable medium of claim 8, wherein the computer-executable instructions for performing a method further comprise instructions for:
establishing a link between each rejected claim in the claim tree and a corresponding claim attack diagram;
receiving selection information for a rejected claim; and
rendering the corresponding claim attack diagram upon receiving the selection information.

10. A system for analyzing rejected claims of a patent application, comprising:
means for analyzing a set of claims to form a claim hierarchy;
means for receiving rejection information pertaining to the set of claims; and
means for rendering a graphical representation of the set of claims as a claim tree, the claim tree comprising a plurality of claim icons, and wherein a rejection status for each claim is indicated in the claim tree.

11. The system of claim 10, wherein the means for rendering a graphical representation of the set of claims in a claim tree, further comprises:
means for rendering a claim information box, the claim information box comprising a claim field, claim rejection code, and rejection elements field, and
means for rendering a rejection summary in a proximal location to the claim tree.

12. The system of claim 10, further comprising means for rendering a first shape for each claim icon within a claim tree that is rejected, and means for rendering a second shape for each claim icon within a claim tree that is not rejected.

13. The system of claim 10, further comprising means for rendering in a first color, each claim icon within a claim tree that is rejected, and means for rendering in a second color, each claim icon within a claim tree that is not rejected.

14. The system of claim 10, further comprising means for generating a claim attack diagram for each rejected claim.

15. The system of claim 14, wherein the means for generating a claim attack diagram further comprises:
means for rendering a claim icon indicative of a rejected claim;
means for rendering a reference icon for each reference set used to reject the rejected claim; and
means for rendering a connection between each reference icon and the claim icon.

16. The system of claim 15, further comprising means for rendering a claim element label proximal to each connection.

17. The system of claim 16, further comprising:
means for establishing a link between each rejected claim in the claim tree and a corresponding claim attack diagram;
means for receiving selection information for a rejected claim; and
means for rendering the corresponding claim attack diagram upon receiving the selection information.

18. The system of claim 10, wherein the means for rendering a graphical representation of the set of claims in a claim tree comprises images of graphs that are embedded in an HTML web page.

19. The system of claim 17, wherein the means for rendering the corresponding claim attack diagram upon receiving the selection information comprises:
an image file of the claim attack diagram, said image file embedded in an HTML file;
a map file, said map file providing location information for each claim icon, and providing a URL to a corresponding claim attack diagram for each claim; and
an HTML browser, said HTML browser configured to render the HTML file.

20. The system of claim 12, wherein the first shape is an oval, and the second shape is a rectangle.
